(19) United States
(12) Patent Application Publication
(10) Pub. No.: US 2010/0036981 A1
(43) Pub. Date: Feb. 11, 2010

(54) Finding Hot Call Paths

(76) Inventors: Raghavendra Ganesh, Bangalore (IN); Sujoy Saraswati, Bangalore (IN)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/199,612

(22) Filed: Aug. 27, 2008

Related U.S. Application Data
(60) Provisional application No. 61/087,277, filed on Aug. 8, 2008.

(51) Int. Cl. G06F 3/00

(52) U.S. Cl. 710/38

(57) ABSTRACT

Included are embodiments for finding hot call paths. More specifically, at least one embodiment of a method includes creating a structure for at least one function node and creating a directed acyclic graph (DAG) by adding a first root node, the first root node being a virtual root node. Some embodiments include performing a reverse topological numbering for the DAG.

### CROSS-REFERENCE TO RELATED APPLICATION

This Utility Patent Application is based on and claims the benefit of U.S. Provisional Application No. 61/087,277, filed on Aug. 8, 2008, the contents of which are hereby incorporated by reference in their entirety.

### BACKGROUND

In a computing device, applications may be written using functions. These functions may be configured to call each other to execute at least one of the applications associated with the computing device. A function call hierarchy at any moment of execution of application may be referred to as a call stack. In order to improve the performance of the application, information about the most frequently appearing hot call stacks may be utilized. As a nonlimiting example, a call graph profile of a computing application maybe used as a performance analysis technique by many profiling tools. These profiling tools may be configured to show the call graph profiles in terms of samples and/or the time spent in each of the function, as well as the number of calls from parent functions and to each child function. However, these current solutions cannot show complete stack information to hot functions in execution.

### SUMMARY

Included are embodiments for finding hot call paths. More specifically, at least one embodiment of a method includes creating a structure for at least one function node and creating a directed acyclic graph (DAG) by adding a first root node, the first root node being a virtual root node. Some embodiments include performing a reverse topological numbering for the DAG.

Also included are embodiments of a system. At least one embodiment includes a first creating component configured to create a structure for at least one function node and a second creating component configured to create a directed acyclic graph (DAG) by adding a first root node, the first root node being a virtual root node. Additionally, some embodiments include a performing component configured to perform a reverse topological numbering for the DAG.

Other embodiments and/or advantages of this disclosure will be or may become apparent to one with skill in the art upon examination of the following drawings and detailed description. It is intended that all such additional systems, methods, features, and advantages be included within this description and be within the scope of the present disclosure.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

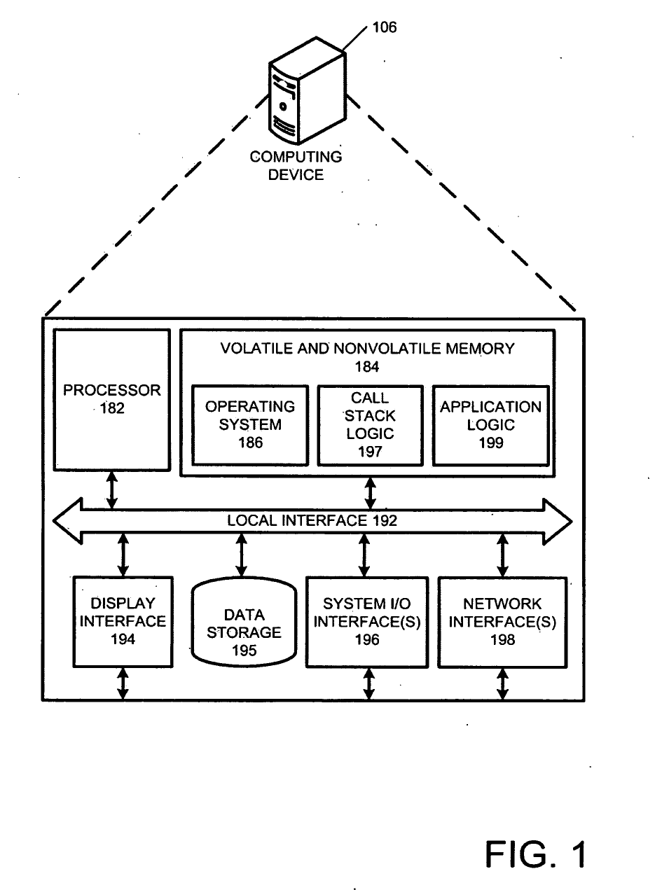

FIG. 1 depicts an exemplary embodiment of a computing device, which may be configured to execute at least one application.

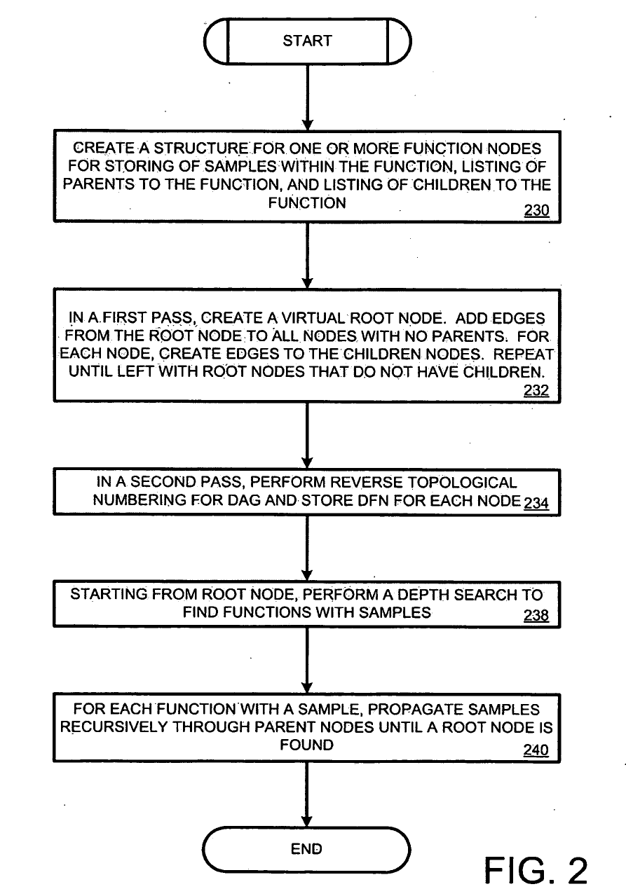

FIG. 2 depicts an exemplary flowchart for locating a root node, such as may be performed by the computing device, from FIG. 1.

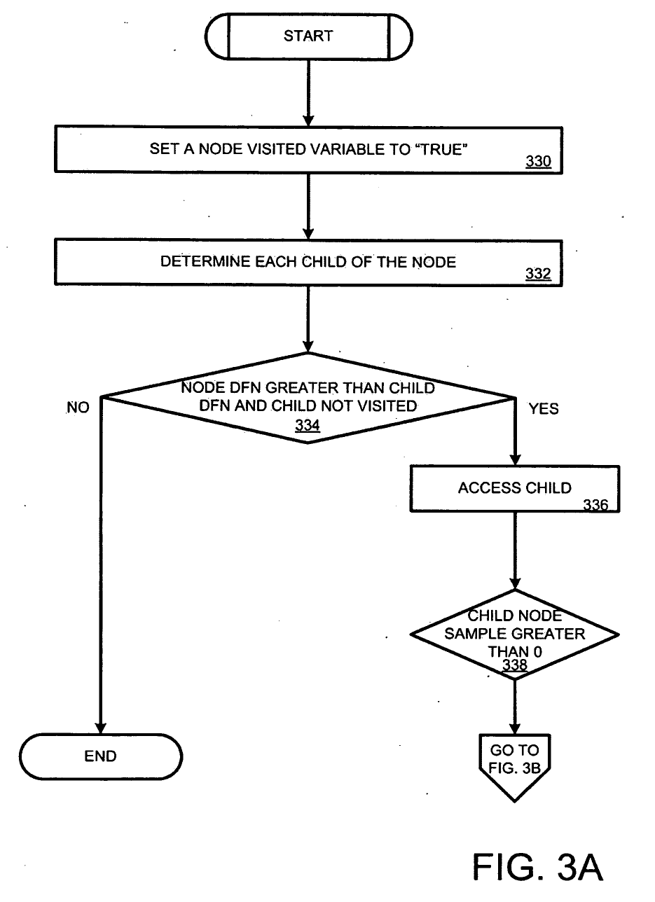

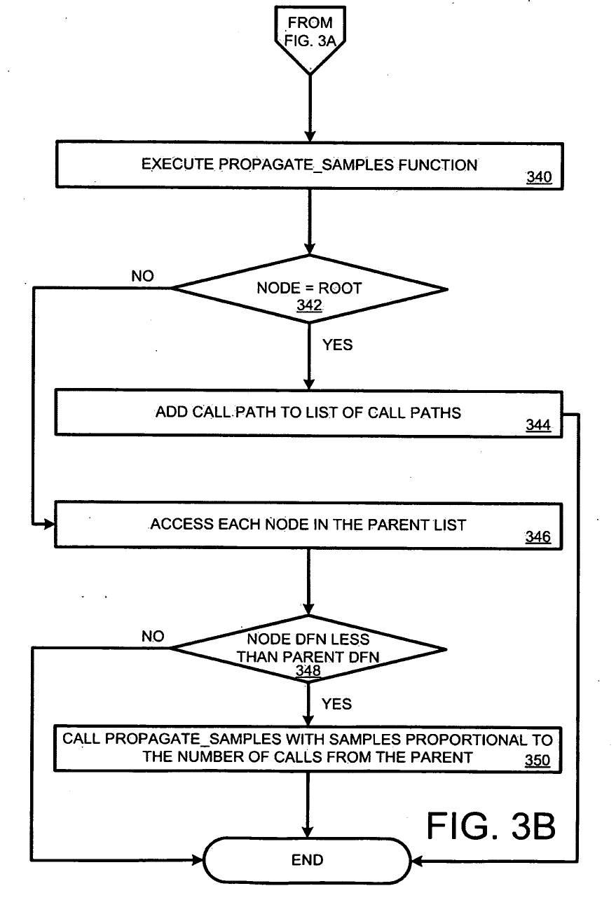

FIGS. 3A and 3B depict an exemplary flowchart for retrieving hot call paths, similar to the diagram from FIG. 2.

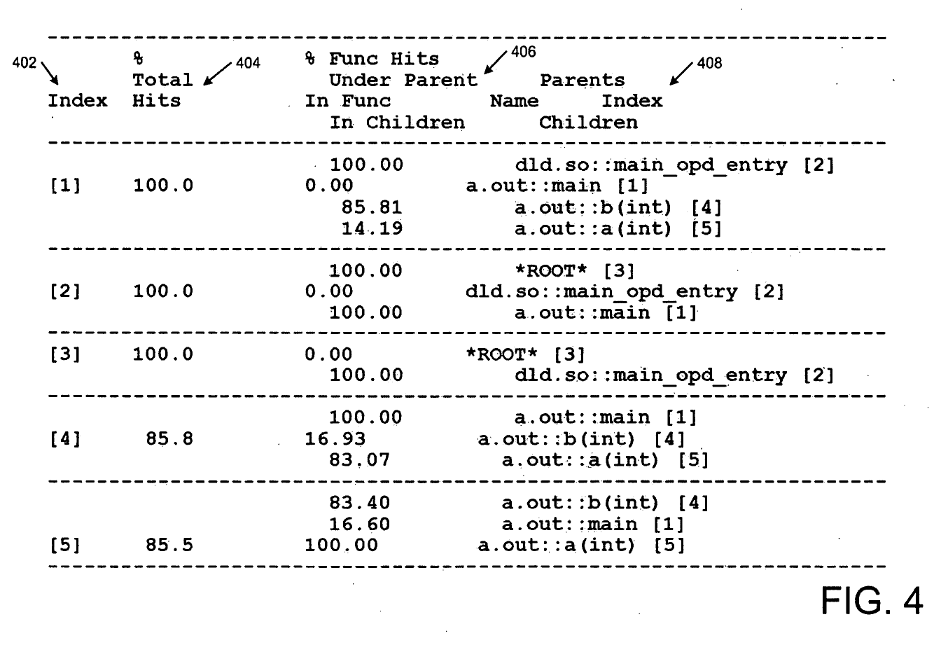

FIG. 4 depicts an exemplary embodiment of a call graph profile, such as may be created by the computing device, from FIG. 1.

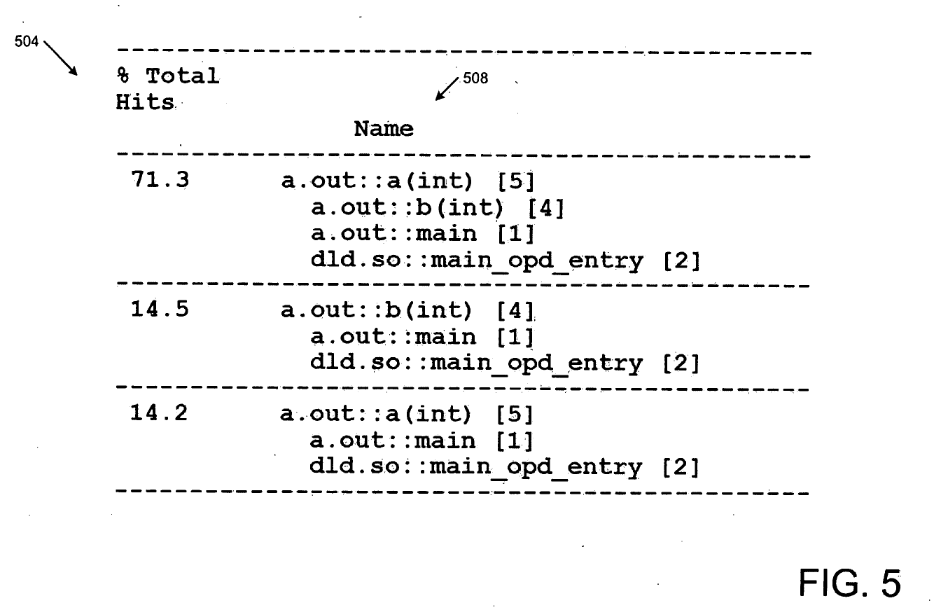

FIG. 5 depicts an exemplary embodiment of a call stack profile, indicating a total number of hits, as well as a call stack profile, similar to the diagram from FIG. 4.

### DETAILED DESCRIPTION

Although embodiments disclosed herein can be used in a plurality of different tools, such as Hewlett Packard® Caliper, GNU g-profiler, Intel® Vtune, Rational Quantify, at least a portion of this disclosure may be directed to an HP caliper protocol. On an Itanium architecture, using sampling in a performance monitoring unit (PMU) interface, caliper can collect information such as call count samples and samples within a function. Caliper can also retrieve the exact call count information for each function, using dynamic instrumentation.

However, in at least one embodiment, PMU hardware (and/or software) may be configured to provide limited stack trace information (e.g., a stack depth of 4) for a function sample. With this information, caliper reports may show a sample of the hits for a function and call counts to each parent function and child function. Given this call graph report, users may manually determine a possible hottest stack trace in an application. This can be completed by the user manually tracing functions with high samples through the associated parent function. While results may be obtained in this manner, such an implementation may be tedious and sometimes difficult to accurately perform.

Additionally, other tools that show complete call paths may be utilized, but oftentimes these tools do not show the “hotness” associated with the call paths. Further, many of these tools often rely on stack unwinding support. The remote unwinding support may not available on all systems, making such an approach unavailable to tools that gather data about another process.

Caliper itself may include a cstack measurement to show hot call paths, but caliper may utilize a different technology than call graphs. This technology may require unwinding and tracing support. The unwinding samples taken at regular intervals may include a high overhead when the process includes numerous threads. Also, this technology may not be configured to extend to a system-wide scenario. Generally, if the hot process is not known in a system, users can perform a system-wide run to determine data about all processes and look into the details of the top few processes. An unwinding approach may not be configured for use for system-wide call-path profiling. The approach discussed below may not be limited by the unwinding approach to collect call stack samples. The embodiments described below may include a hardware and/or software sampling technique and may be configured for utilization in a system-wide mode.

Referring now to the drawings, FIG. 1 depicts an exemplary embodiment of a computing device, which may be configured to execute at least one application. Although a wire-line device is illustrated, this discussion can be applied to wireless devices, as well. Generally, in terms of hardware architecture, as shown in FIG. 1, the computing device 106 includes a processor 182, memory component 184, a display interface 194, data storage 195, one or more input and/or output (I/O) device interface(s) 196, and/or one or more network interface 198 that are communicatively coupled via a local interface 192. The local interface 192 can include, for example but not limited to, one or more buses or other wired or wireless connections. The local interface 192 may have additional elements, which are omitted for simplicity, such as controllers, buffers (caches), drivers, repeaters, and receivers to enable communications. Further, the local interface may include address, control, and/or data connections to enable appropriate communications among the aforementioned components. The processor 182 may be a device for executing software, particularly software stored in memory component 184.

The processor 182 can be any custom made or commercially available processor, a central processing unit (CPU), an auxiliary processor among several processors associated with the computing device 106, a semiconductor based microprocessor (in the form of a microchip or chip set), a macroprocessor, or generally any device for executing software instructions.

The memory component 184 can include any one or combination of volatile memory elements (e.g., random access memory (RAM, such as DRAM, SRAM, SDRAM, etc.)) and/or nonvolatile memory elements (e.g., ROM, hard drive, tape, CDROM, etc.). Moreover, the memory 184 may incorporate electronic, magnetic, optical, and/or other types of storage media. One should note that the memory component 184 can have a distributed architecture (where various components are situated remote from one another), but can be accessed by the processor 182. Additionally, memory component 184 can include application logic 199, call stack logic 197, and an operating system 186. In operation, the application logic 199 may include one or more applications, as well as tools such as Hewlett Packard® Caliper, GNU g-profiler, Intel® Vtune, Rational Quantify, embodiments disclosed herein may be directed to an HP caliper protocol. Additionally, depending on the particular configuration, the computing device 106 may be configured with an Itanium architecture; however, this is not a requirement. Similarly, the call stack logic 197 may include one or more components configured to perform at least a portion of the functions discussed herein.

A system component and/or module embodied as software may also be construed as a source program, executable program (object code), script, or any other entity comprising a set of instructions to be performed. When constructed as a source program, the program is translated via a compiler, assembler, interpreter, or the like, which may or may not be included within the memory component 184, so as to operate, properly in connection with the operating system 186.

The input/output devices that may be coupled to system I/O Interface(s) 196 may include input devices, for example but not limited to, a keyboard, mouse, scanner, microphone, etc. Further, the input/output devices may also include output devices, for example but not limited to, a printer, display, speaker, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

Additionally included are one or more network interfaces 198 for facilitating communication with one or more other devices. More specifically, network interface 198 may include any component configured to facilitate a connection with another device. While in some embodiments, among others, the computing device 106 can include a network interface 198 that includes a personal computer memory card international association (PCMCIA) card (also abbreviated as “PC card”) for receiving a wireless network card, however this is a nonlimiting example. Other configurations can include the communications hardware within the computing device, such that a wireless network card is unnecessary for communicating wirelessly. Similarly, other embodiments include network interfaces 198 for communicating via a wired connection. Such interfaces may be configured with universal serial bus (USB) interfaces, serial ports, and/or other interfaces.

If computing device 106 includes a personal computer, workstation, or the like, the software in the memory component 184 may further include a basic input output system (BIOS) (omitted for simplicity). The BIOS is a set of software routines that initialize and test hardware at startup, start the operating system 186, and support the transfer of data among the hardware devices. The BIOS may be stored in ROM so that the BIOS can be executed when the computing device 106 is activated.

When the computing device 106 is in operation, the processor 182 may be configured to execute software stored within the memory component 184, to communicate data to and from the memory component 184, and to generally control operations of the computing device 106 pursuant to the software. Software in memory, in whole or in part, may be read by the processor 182, perhaps buffered within the processor 182, and then executed.

One should note that while the description with respect to FIG. 1 includes a computing device 106 as a single component, this is a nonlimiting example. More specifically, in at least one embodiment, computing device 106 can include a plurality of servers, personal computers, and/or other devices. Similarly, while application logic 199 and call stack logic 197 are illustrated in FIG. 1 as single software components, this is also a nonlimiting example. In at least one embodiment, application logic 199 and the call stack logic 197 may include one or more components, embodied in software, hardware, and/or firmware. Additionally, while application logic 199 is depicted as residing on a single computing device, as computing device 106 may include one or more devices, application logic 199 may include one or more components residing on one or more different devices.

Embodiments disclosed herein may operate on ingredients utilized to build a call graph, such as program counter samples and function call branch source-target pair and call counts. This data may already be collected by one or more tools on the computing device 106. At least one embodiment disclosed herein may be configured to utilize existing data to build a most probable hot path profile of an application.

Using the call count information, caliper (which may be included in the application logic 199 and/or elsewhere) may be configured to create a structure for one or more function nodes for storing of samples within the function, listing of parents to the function, and listing of children to the function. Once the individual function nodes are established, a directed acyclic graph (DAG) structure may be created in a single pass. This may be accomplished by starting from nodes that have no parents and add a virtual root node as a parent to these nodes. In a depth-first manner, children may continue to be added until a leaf node is reached. Cycles may be handled with a special “cycle entry” node which may virtually contain all the members of a cycle.

Similarly, in a second pass, reverse topological numbering for the DAG may be performed and depth first number (DFN) may be stored for each node. This result may represent at least one embodiment of the call graph structure from which hot call paths can be reported.

With these structures in place, hot call paths may be retrieved, as described below. Starting from a root node, a depth search may be performed to find functions that have samples. For each function that has at least one sample, the samples may be propagated through each of the parent functions recursively, until the root node is found. Cycles may be avoided using the DFN fields of the function nodes. It is also possible to restrict the number of hot call paths generated using a list to maintain the hot paths so that top N hot call paths could be generated. Below is listed exemplary pseudo code for the retrieval of hot call paths. Invocation is using DFS(root).

```
DFS(node):
node->visited = true
For each child in node->children_list:
  if node->DFN > child->DFN and child is not visited:
DFS(child)
if node->sample > 0:
  propagate_samples(node, node->samples).
```

Below is pseudo code for propagating samples from a node:

```
    propagate_samples(node, samples):
    if node == root:
      Add the call path to the list of call paths
    else,
    for each parent in node->parent_list:
      if node->DFN < parent->DFN:
        propagate_samples(parent, samples X (number of calls from
parent) / (total calls from parents))
```

The samples in a node may be distributed among parents in the proportion of number of calls from each parent. This may not be true, but that is the most likely distribution without knowing the whole call path information. Additionally, there could be some false positives as well. As a nonlimiting example, while in execution there could be two call paths:

funA( )->funBQ->funC( ); and

funD( )->funB( )->funE( ).

However, due to lack of complete stack trace information all the following four call paths may be present: funA( )->funB( )->funCQ, funA( )->funBQ→funE( ), funDQ->funB( )->funC( ) and funD( )->funB( )->funE( ).

Also with sampling of the PMU, there could be false negatives as well. As a nonlimiting example, if a particular function call funA( )->funB( ) is not captured in any of the PMU samples, no call paths containing funA( )->funB( ) will be reported. This problem does not occur with instrumented call graph profiles where the exact call count information is stored.

Referring again to the drawings, FIG. 2 depicts an exemplary flowchart for locating a root node, such as may be performed by the computing device 106, from FIG. 1. As illustrated in the nonlimiting example of FIG. 2, a structure for one or more function nodes may be created for storing samples within a function. Additionally, a listing of parents to the function and children of the function may also be created (block 230). In a first pass, a virtual root node may be created. Additionally edges from the root node to all nodes with no parents may be added. For each node edges to the children nodes may be created. This may be repeated until left with leaf nodes that have no children (block 232). In a second pass, a reverse topological numbering may be performed for DAG and the DFN for each node may be stored (block 234). Starting from the root node, a depth search may be performed to find functions within the samples (block 238). Further, for each function with a sample, the samples may be recursively propagated through the parent nodes until a root node is found (block 240).

FIGS. 3A and 3B depict an exemplary flowchart for retrieving hot call paths, similar to the diagram from FIG. 2. As illustrated in the nonlimiting example of FIG. 3A, a node visited variable for a node may be set to “true” (block 330). Additionally, each child of the node may be determined (block 332). If, at block 334, a node DFN is greater than a child DFN, and the child is not visited, the flowchart may proceed to block 336 to access the child node. If, at block 334, one or more of these conditions are not met, the flowchart may end. From block 336, the flowchart can proceed to block 338, where a determination can be made whether the child node sample is greater than zero. If not, the flowchart can end. If so, the flowchart can proceed to block 340, in FIG. 3B.

FIG. 3B depicts a continuation of the flowchart from FIG. 3A. More specifically, in FIG. 3B, a propagate_samples function may be executed (block 340). Additionally, a determination can be made whether the current node is a root node (block 342). If not, the flowchart proceeds to block 346. If so, a call path for the current node can be added to a list of call paths (block 344). From block 344, the process may end. Additionally, from block 342, each node in the parent list may be accessed (block 346). A determination can also be made regarding whether the node DFN is less than the parent DFN (block 348). If not, the flowchart may end. If so, the propagate samples function may be called with samples proportional to the number of calls from the parent (block 350).

FIG. 4 depicts an exemplary embodiment of a call graph profile, such as may be created by the computing device 106, from FIG. 1. More specifically, index field 402 may be configured to indicate the index being displayed. The percentage of total hits field 404 may be configured to indicate a percentage of hits resulting from a search. The percentage function hits field 406 may be configured to display the percentage of hits under the parent, percentage of hits in the function, and percentage of hits in the children. Similarly, a family field 408 may be configured to list the parents' name and index, as well as the children's name and index.

More specifically, as a nonlimiting example, index [1] (field 402) received 100% of the total hits (field 404). Additionally, index [1] received 100% of the function hits under the parent node, 0% of the hits in the function, and 85.81% and 14.19% of the hits in the two children (field 406). As indicated in field 408, the index [1] has a parent dld.so::main_opd_entry in index [2], and children a.out::b and a.out::b in indices [4], and [5], respectively. Similar information may be derived for indices [2]-[5]. From this call graph profile, it may be difficult for the user to figure out manually how the executing application is spending most of it's time. Generally, the user can manually traverse from a hot function index through parents recursively to analyze the call path. This may be tedious at times and sometimes difficult (if not impossible) to do when huge number of functions are present.

FIG. 5 depicts an exemplary embodiment of a call stack profile, indicating a total number of hits, as well as the call stack information, similar to the diagram from FIG. 4. More specifically, in a first row, the total number of hits for the given call stack is 71.3 (field 504). Additionally, the call stack may include a.out::a(int), which is associated with index [5]; a.out::b(int), associated with index [4]; a.out::main, associated with index [1], and dld.so::main_opd_entry, associated with index [2] (field 508)). In this call stack profile, the user directly gets the information about the hottest call stacks while the application was executing.

The embodiments disclosed herein can be implemented in hardware, software, firmware, or a combination thereof. At least one embodiment disclosed herein may be implemented in software and/or firmware that is stored in a memory and that is executed by a suitable instruction execution system. If implemented in hardware, one or more of the embodiments disclosed herein can be implemented with any or a combination of the following technologies: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

One should note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order and/or not at all. For example, two blocks shown in succession may in fact be executed substantially concurrently or the blocks may sometimes be executed in the reverse order, depending upon the functionality involved.

One should note that any of the programs listed herein, which can include an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

One should also note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. All such modifications and variations are intended to be included herein within the scope of this disclosure.

Therefore, at least the following is claimed:

1. A method, comprising:
creating a structure for at least one function node;
creating a directed acyclic graph (DAG) by adding a root node, the root node being a virtual root node; and
performing a reverse topological numbering for the DAG.

2. The method of claim 1, further comprising performing a depth search to find at least one function with at least one sample.

3. The method of claim 2, wherein the depth search begins from the virtual root node.

4. The method of claim 1, further comprising recursively propagating at least one sample until the root node is located.

5. The method of claim 1, further comprising:
listing at least one parent of the at least one function node; and
listing at least one child of the function node.

6. A system, comprising:
a first creating component configured to create a structure for at least one function node;
a second creating component configured to create a directed acyclic graph (DAG) by adding a first root node, the first root node being a virtual root node; and
a performing component configured to perform a reverse topological numbering for the DAG.

7. The system of claim 6, further comprising a performing component configured to perform a depth search to find at least one function with at least one sample.

8. The system of claim 7, wherein the depth search begins from the virtual root node.

9. The system of claim 6, further comprising a propagating component configured to recursively propagate at least one sample until a second root node is located.

10. The system of claim 6, wherein the system is embodied as a computer-readable medium.

11. A system, comprising:
means for creating a structure for at least one function node;
means for creating a directed acyclic graph (DAG) by adding a first root node, the first root node being a virtual root node; and
means for performing a reverse topological numbering for the DAG.

12. The system of claim 11, further comprising means for performing a depth search to find at least one function with at least one sample.

13. The system of claim 12, wherein the depth search begins from the virtual root node.

14. The system of claim 11, further comprising means for recursively propagating at least one sample until a second root node is located.

15. The system of claim 11, further comprising:
means for listing at least one parent of the at least one function node; and
means for listing at least one child of the function node.
